(19) United States
(12) Patent Application Publication
(10) Pub. No.: US 2014/0071016 A1
(43) Pub. Date: Mar. 13, 2014

(54) DUAL-BAND AND DUAL-POLARIZATION ANTENNA

(71) Applicants: Yu-Sheng CHEN, Tu-Cheng (TW); Chen-Hsiang CHEN, Tu-Cheng (TW); Chia-Yin LIAO, Tu-Cheng (TW)

(72) Inventors: Yu-Sheng CHEN, Tu-Cheng (TW); Chen-Hsiang CHEN, Tu-Cheng (TW); Chia-Yin LIAO, Tu-Cheng (TW)

(21) Appl. No.: 13/652,595

(22) Filed: Oct. 16, 2012

(30) Foreign Application Priority Data
Sep. 7, 2012 (TW) 101132689

(51) Int. Cl. H01Q 1/38

(52) U.S. Cl. 343/866

(57) ABSTRACT

A dual-band and dual polarization antenna includes a first baseboard and a second baseboard spacing apart from each other. A top surface of the first baseboard includes a first radiation part and a second radiation part. The second radiation part encloses the first radiation part and does not contact the first radiation part. The second baseboard includes a top surface facing the bottom surface of the first baseboard and a bottom surface. The top surface of the second baseboard includes a ground portion and two slot pairs each of which includes two slots. The two slots comprised in each slot pair are symmetrical to each other, and the symmetrical center of each slot pair aligns with the center of the first radiation part. The bottom surface includes a first microstrip line and a second microstrip line for feeding back wireless signals.

### BACKGROUND

1. Technical Field

The present disclosure relates to a dual-band and dual-polarization antenna.

2. Description of Related Art

With the increase in functionality of electronic devices, the need for more than one kind of antenna in a single device has also increased. For example, there are devices which offer both WiFi and GSM communication functions. There are dual-band and dual-polarization antennas that can receive two different wireless signals and the dual-band and dual-polarization antenna generally includes two antennas, but the isolation between the two antennas of the dual-band and the dual-polarization antenna is low.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like reference numerals designate corresponding parts throughout several views.

FIG. 1 is an isometric view of a dual-band and dual polarization antenna in accordance with an exemplary embodiment.

FIG. 2 is a top plan view of a first baseboard of the antenna of FIG. 1.

FIG. 3 is a front elevational view of a second baseboard of the antenna of FIG. 1.

FIG. 4 is a top plan view of a second baseboard of the antenna of FIG. 1.

FIG. 5 is a bottom plan view of the second baseboard of the antenna of FIG. 1.

FIG. 6 is an electrical characteristics diagram of the antenna of FIG. 1

### DETAILED DESCRIPTION

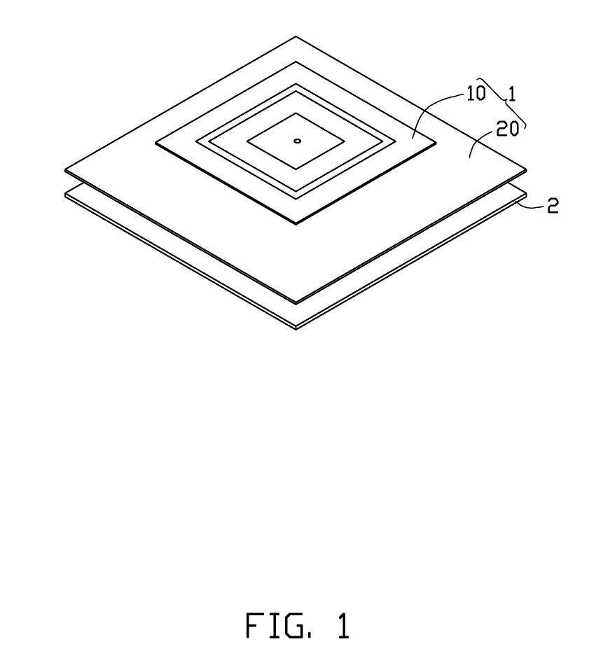

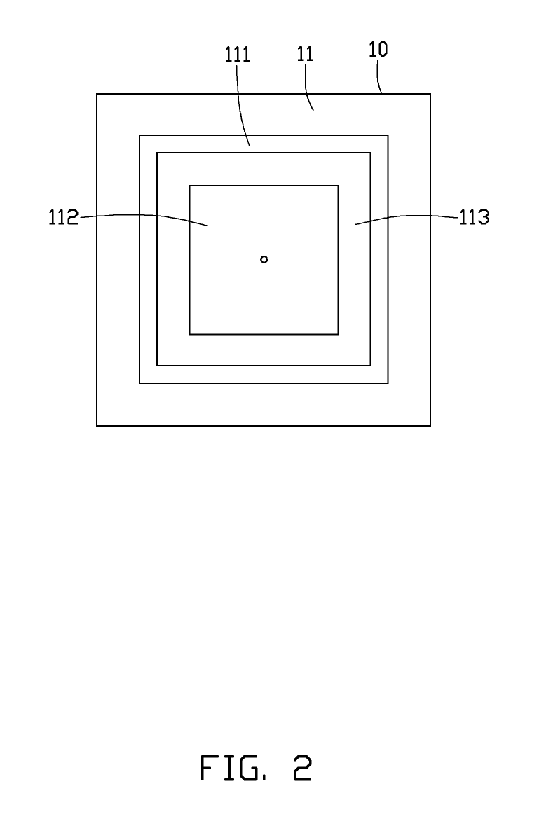

FIG. 1 is a schematic view of a dual-band and dual polarization antenna 1 in accordance an exemplary embodiment. The antenna 1 includes a first baseboard 10 and a second baseboard 20. As shown in FIG. 2, a top surface 11 of the first baseboard includes a first radiation part 111 and a second radiation part 112. The first radiation part 111 and the second radiation part 112 are both metal. The second radiation part 111 encloses the first radiation part 112 and does not contact the first radiation part 112, and the first radiation part 112 and the second radiation part 111 both are metallic patch with regular shape, such as square. In the embodiment, the first radiation part 111 is shaped as a picture frame and frames the second radiation part 112, which is square, without contacting it, leaving a space 113 between the first radiation part 111 and the second radiation part 112 of uniform width.

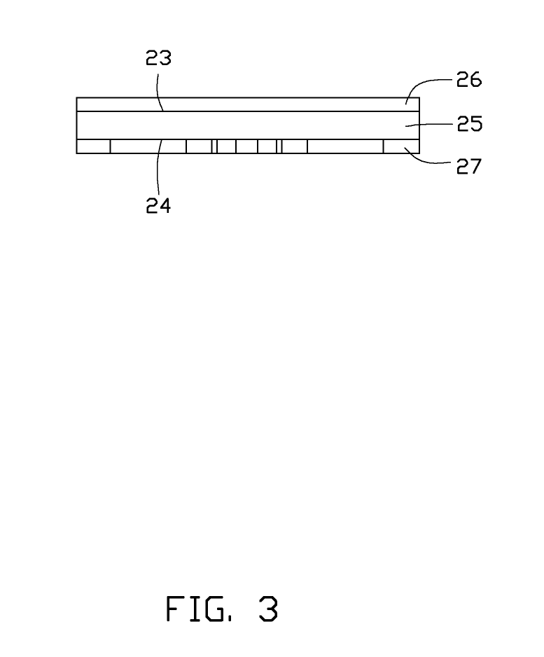

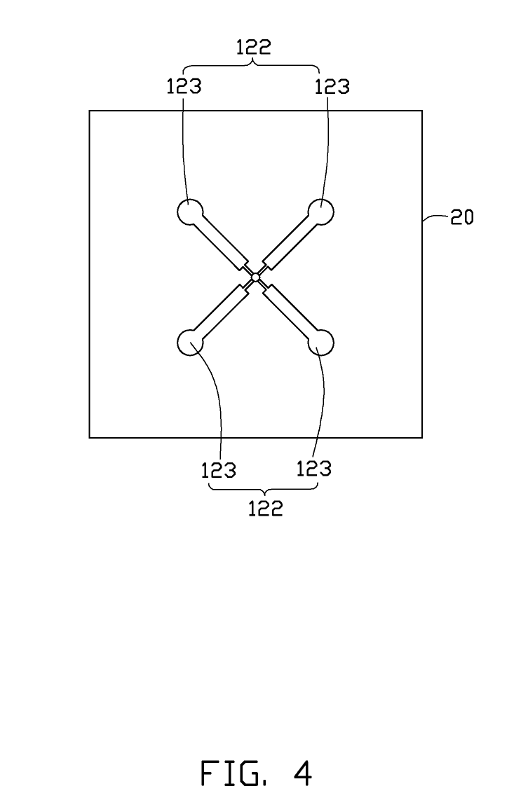

As shown in FIG. 3, the second baseboard 20 underneath the first baseboard 10 includes a base layer 25, a ground layer 26, and a microstrip layer 27. As shown in FIG. 4, the ground layer 26 lays on a top surface 23 of the base layer 25 and is made of metal. In the embodiment, the shape and size of the ground layer 26 is the same as the base layer 25. But in other embodiments, the shape and size of the ground layer 26 can be changed according to actual requirements. The ground layer 26 includes at least one pair of through slots 122 (hereinafter “slot pair”) to expose the top surface 23 of the base layer 25. The two through slots 123 included in each slot pair 122 are symmetrical to each other. The shape of the through slots 123 can be changed according to actual requirements. In the embodiment, two slot pairs 122 are taken for example. The symmetrical center of the four slots 122 aligns with the center of the first radiation part 111. The ground layer 26 of the second baseboard 20 faces the bottom surface of the first baseboard 10.

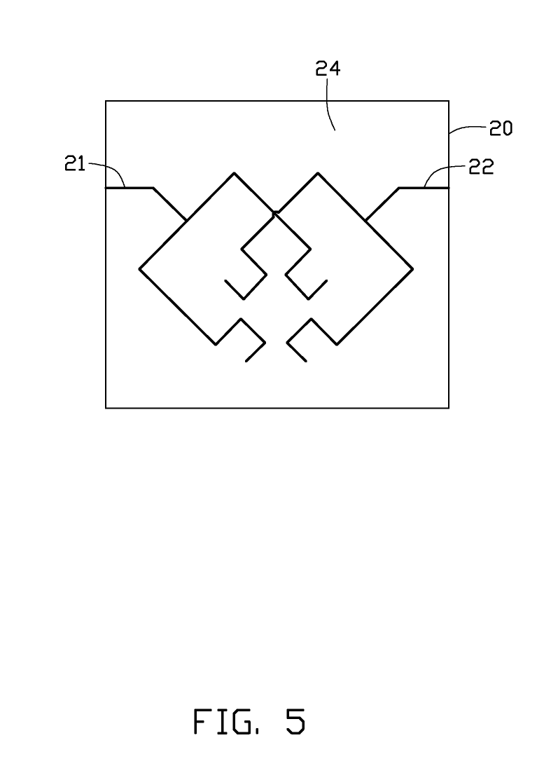

As shown in FIG. 5, the microstrip layer 27 includes a first microstrip line 21 and a second microstrip line 22 for feeding back wireless signals. The two microstrip lines 21 and 22 are placed on the bottom surface 24 of the base layer 25 and are dual polarized. In the embodiment, the polarization direction of the two microstrip lines 21 and 22 respectively are ±45°. The first microstrip lines 21, the first radiation part 111, and the second radiation part 112 corporately form a first antenna (not shown). The second microstrop lines 22, the first radiation part 111, and the second radiation part 112 corporately form the second antenna (not shown). Due to dual polarization of the first microstrip line 21 and the second microstrip line 22, the first antenna and the second antenna are well isolated.

The first baseboard 10 and the second baseboard 20 are spaced a predetermined distance from each other. In the embodiment, the distance between the first baseboard 10 and the second baseboard 20 is 18 mm. When fixing the antenna 1 to an electronic device (not shown), the second baseboard 20 is set 15 mm from a housing 2 of the electronic device.

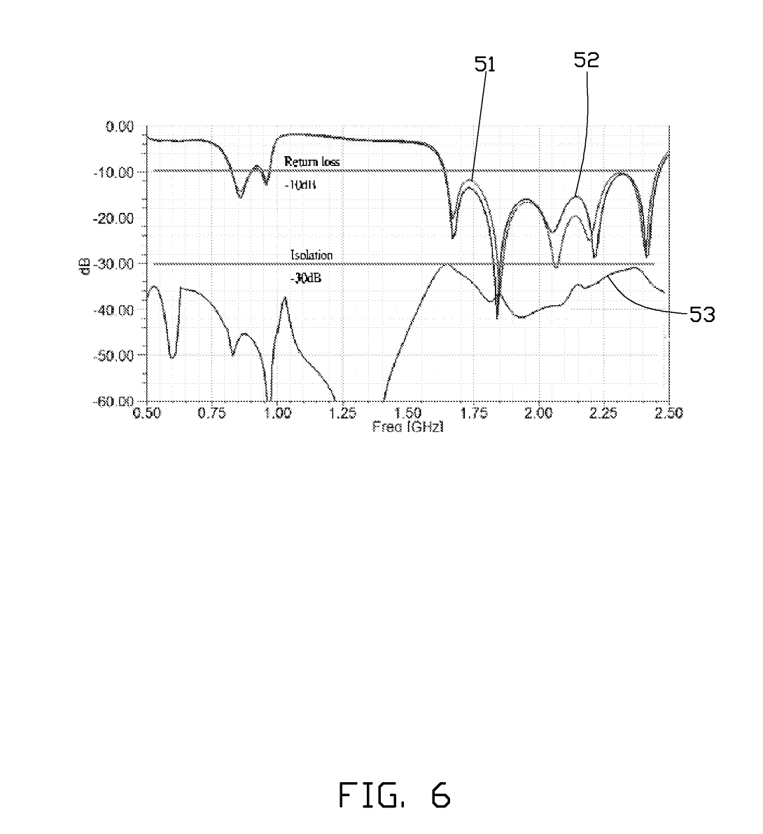

FIG. 6 is an electrical characteristics diagram of the antenna 1 of FIG. 1. The diagram shows a first curve 51, a second curve 52, and a third curve 53. The first curve 51 shows the return loss of signals fed back by the first microstrip line 21. The second curve 52 shows the return loss of signals fed back by the second microstrip line 22. The third curve 53 shows the isolation between the first antenna and the second antenna. In the embodiment, the antenna 1 can reach two frequency bands, which respectively are 880˜960 MHz and 1710˜2170 MH. In FIG. 6, the first curve 51 and the second curve 52 both include the two frequency bands, and the isolation between the first antenna and the second antenna is substantially below −30 db as indicated by the third curve 53.

Although the present disclosure has been specifically described on the basis of preferred embodiments, the disclosure is not to be construed as being limited thereto. Various changes or modifications may be made to the embodiment without departing from the scope and spirit of the disclosure.

What is claimed is:

1. A dual-band and dual polarization antenna comprising:
a first baseboard, a top surface of which comprises a first radiation part and a second radiation part, wherein the second radiation part encloses the first radiation part and does not contact the first radiation part, and the first radiation part and the second radiation part both being metallic patch with regular shape; and
a second baseboard underneath and spacing a predetermined distance from the first base board, the second baseboard comprising:
a base layer;
a ground layer laying on a top surface of the base layer and facing a bottom surface of the first baseboard, comprising at least one through slot pair, wherein the two slots in each of the at least one through slot pair are symmetrical to each other, and the symmetrical center of at least one slot pair aligns the center of the first radiation part; and
a microstrip layer being placed on a bottom surface of the base layer comprising a first microstrip line and a second microstrip line, which are dual polarized, for feeding back wireless signals.

2. The antenna as described in claim 1, wherein the first radiation part is shaped as a picture frame and frames the second radiation part, the second radiation part is square-shaped.

3. The antenna as described in claim 1, wherein a space between the first radiation part and the second radiation part has a uniform width.

4. The antenna as described in claim 1, wherein the number of the at least one through slot pair is two.

5. The antenna as described in claim 1, wherein the ground layer is made of metal.

6. The antenna as described in claim 1, wherein the polarization direction of the first microstrip line and the second microstrip line respectively are ±45°.

7. The antenna as described in claim 1, wherein the distance between the first baseboard and the second baseboard is 18 mm.

8. The antenna as described in claim 1, wherein when fixing the antenna to an electronic device, the second baseboard distances a housing of the electronic device for 15 mm.

9. The antenna as described in claim 1, wherein frequency bands which the antenna reaches respectively are 880˜960 MHz and 1710˜2170 MH.
